(19) United States
(12) Patent Application Publication
(10) Pub. No.: US 2025/0392514 A1
(43) Pub. Date: Dec. 25, 2025

(54) FRAMEWORK TO PREDICT AND AUTOMATE CUSTOMER ACTIONS IN RESPONSE TO WEBHOOK NOTIFICATIONS

(71) Applicant: Hewlett Packard Enterprise Development LP, Spring, TX (US)

(72) Inventors: Michael Karl Forsberg, Austin, TX (US); Latha Srinivasan, San Jose, CA (US); James Eugene Wade, Fort Collins, CO (US); Evan S. G. Forrey, Westminster, CO (US)

(21) Appl. No.: 18/752,479

(22) Filed: Jun. 24, 2024

(51) Int. Cl. H04L 41/08; H04L 41/0631; H04L 41/0823

(52) U.S. Cl. CPC H04L 41/0886; H04L 41/0631; H04L 41/0836

(57) ABSTRACT

A computer receives, from a network device which communicates using a web-based protocol, a webhook requesting a notification for a first event associated with a first resource monitored by the computer. The computer detects an occurrence of the first event and transmits the notification to the network device. The computer stores, in a data structure, information associated with the notification. The computer monitors requests received from the network device using the web-based protocol subsequent to transmitting the notification to the network device and stores, in the data structure, information associated with a respective monitored request. The computer queries the data structure for requests associated with the first resource and a predefined period of time. The computer correlates the webhook and the queried requests. The computer improves efficiency associated with operating the first resource by performing an action based on the correlation.

### BACKGROUND

### Field

A compute management platform can help a customer gain visibility into a distributed compute environment by providing webhook functionality. A customer can register a “webhook” with the management platform which requests a notification when a specific event associated with a resource has occurred by using a web-based application programming interface (API). Customers can subsequently invoke operational changes to their distributed compute environment based on webhook notifications by issuing calls using the web-based API. Currently, no solution exists to analyze requests sent by the customer subsequent to the notification in order to identify a correlation with the webhook and to proactively improve operational health of their compute infrastructure.

### BRIEF DESCRIPTION OF THE FIGURES

FIG. 1 illustrates an environment which facilitates a framework to predict and automate customer actions in response to webhook notifications, in accordance with an aspect of the present application.

FIG. 2 illustrates a diagram of communications which facilitates a framework to predict and automate customer actions in response to webhook notifications, in accordance with an aspect of the present application.

FIG. 3A presents a table depicting stored information associated with notifications sent in response to webhooks, in accordance with an aspect of the present application.

FIG. 3B presents a table depicting stored information associated with monitored REST requests, in accordance with an aspect of the present application.

FIG. 4A presents a flowchart illustrating a method which facilitates a framework to predict and automate customer actions in response to webhook notifications, in accordance with an aspect of the present application.

FIG. 4B presents a flowchart illustrating a method which facilitates a framework to predict and automate customer actions in response to webhook notifications, in accordance with an aspect of the present application.

FIG. 5 illustrates a computer system which facilitates a framework to predict and automate customer actions in response to webhook notifications, in accordance with an aspect of the present application.

FIG. 6 illustrates a computer-readable medium which facilitates a framework to predict and automate customer actions in response to webhook notifications, in accordance with an aspect of the present application.

In the figures, like reference numerals refer to the same figure elements.

### DETAILED DESCRIPTION

Aspects of the instant application provide a system which improves the efficiency of utilization of resources by predicting and automating customer actions in response to webhook notifications.

A compute management platform can use a software-defined approach to provide storage management services to customers based on a unified data management framework. The compute management platform can reside on a single computer or computing device or may be distributed across multiple computing devices in a network. A customer operating in a distributed compute environment may wish to gain visibility into the operations of its distributed compute environment. The compute management platform can aid the customer in gaining such visibility by providing webhook functionality. Using a web-based API (such as a Representational State Transfer (REST) API), a customer can register a webhook with the compute management platform by requesting a notification when an event associated with a resource has occurred. Upon detecting that the registered event has occurred, the compute management platform can send the requested notification to the customer. Subsequent to receiving the webhook notification, the customer may invoke operational changes to their distributed compute environment by sending requests using the web-based API (e.g., REST requests). Currently, no solution exists to analyze the requests sent by the customer subsequent to the notification in order to identify a correlation with the webhook and to improve the efficiency of the resource utilization, including the operational health and efficiency of their compute infrastructure.

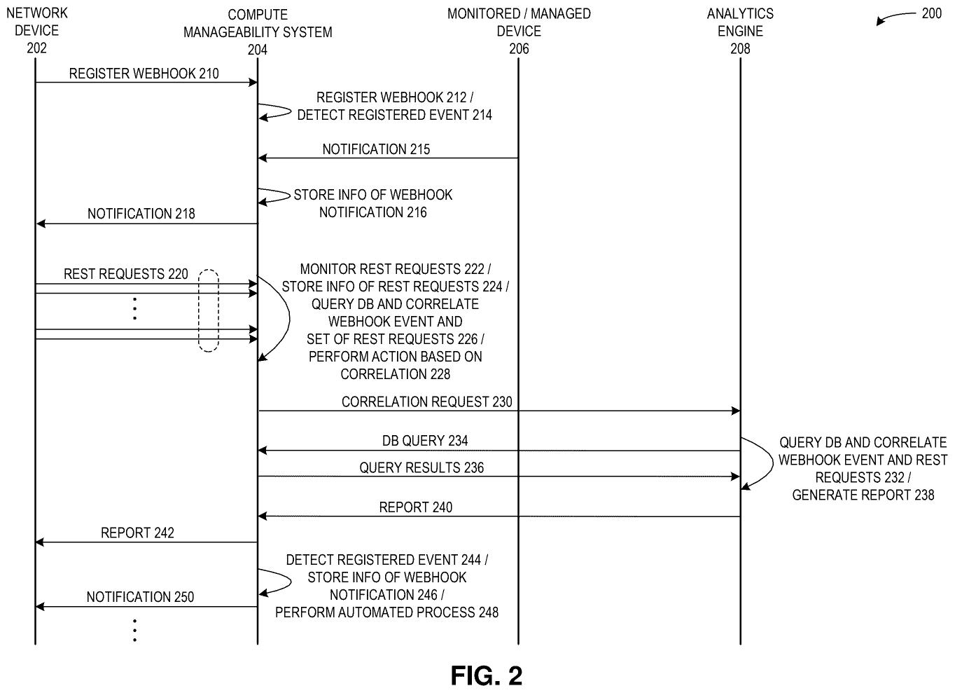

The described system can refer to a compute management system which provides a solution that improves the efficiency of utilization of resources by leveraging information stored in a database relating to historical webhook events for a particular resource (i.e., notifications) sent to the customer and corresponding web-based requests associated with the same resource sent by the customer after receiving the notifications. In this disclosure, the compute management system may also be referred to as a “compute manageability solution.” Furthermore, while the REST API is used to describe aspects of the system, other web-based APIs may be used, e.g., including, but not limited to, a Simple Object Access Protocol (SOAP) API, an API based on Hypertext Transfer Protocol (HTTP), or an API based on HyperText Markup Language (HTML), Extensible Markup Language (XML), or JavaScript Object Notation (JSON). In the below Figures, the compute management system may also be referred to as a “system,” “computing system,” “computer system,” or “computer.” For each received REST request that matches a resource for which a webhook (and associated information) is stored in the database, the system can store the REST request (and associated information) in the database. The system or an administrative user can run a periodic query on the database to find a set of REST requests matching a given resource and a given event (specified in a registered webhook) over, e.g., a predetermined time window. The system can correlate the webhook with the resulting set of REST requests and aggregate the set of REST requests into a single REST operation to provide an automated process for “opted-in” customers, i.e., customers who have previously agreed to opt-in to having the automated process configured by the system. The automated process can perform the single REST operation in response to subsequently detecting the given event associated with the given resource (i.e., detecting another occurrence of the event indicated in the webhook). The system can also provide an interactive mechanism which allows a customer to opt in to the automated process, e.g., as a one-time default “always” option or on a “per-approval request” basis. The interactive mechanism is described below in relation to FIG. 2.

Furthermore, the system can generate a report based on any information stored in the database. The report can contain information such as: the correlation between a webhook and a resulting set of REST requests; information associated with a notification and the REST requests; factors used to query a data structure for the resulting set of REST requests; an aggregated REST operation; other correlations between a webhook and other sets of REST requests; and insights related to improving the efficiency associated with operating a resource.

The system can also utilize an analytics engine, which can, e.g.: query the data structure based on different factors; identify usage patterns corresponding to a respective customer, event, and resource; and correlate a webhook with a resulting set or sets of REST requests. The analytics engine can generate a report similar to that generated by the system, and the report can be provided to an administrative user of the system or a customer associated with a registered webhook.

The system can further provide information to an administrative user of the management platform (e.g., via a dashboard) which allows the administrative user to gain insight into the operation of the system. The administrative user may view a report and other information generated by the system or the analytics engine. As a result of viewing the report and other information, the administrative user may perform a task which improves the efficiency of the compute management platform (e.g., in a redesign of a product relating to operation of a respective resource) and also aids the customer in improving the efficiency associated with operating the respective resource (e.g., by generating an approval request indicating a response of acceptance or rejection of a suggested optimization or aggregation of REST requests into a single REST operation upon detecting an event identified in a registered webhook).

The term “Representational State Transfer” application programming interface (REST API) refers to a protocol used to communicate via Hypertext Transfer Protocol (HTTP) requests in order to perform standard database or resource management operations, e.g., creating, reading, updating, and deleting records within a resource. A REST API request, call, or command can use any HTTP method to access the state of a resource and can use a variety of formats to return information, e.g., JavaScript Object Notation (JSON) and Extensible Markup Language (XML). The term “web-based protocol” can be based on, e.g., a REST API, a SOAP API, an API based on HTTP, HTML, XML, or JSON. In the Figures below, the REST API is used as an example of the web-based protocol, but other web-based protocols may be used in the manner described herein for the REST API, REST requests, sets of REST requests, etc.

The term “webhook” refers to an HTTP-based communication for a programming function which allows applications to intercept calls or other events which may be of interest. For example, a customer can register a webhook with an infrastructure manageability solution (e.g., a compute management platform), where the webhook indicates or requests a payload (e.g., a notification) from the infrastructure management solution when it detects an occurrence of the indicated event. The infrastructure management solution can send the notification to the customer via a single HTTP POST request.

The terms “automated process” and “automatic process” are used interchangeably in this disclosure and refer to the system executing, on behalf of a user or customer, a single REST operation which includes an aggregation of individual REST requests in response to the system sending a notification of the occurrence of a particular registered webhook event. The automated process can be determined based on a correlation between a webhook event and a set of subsequently received REST requests. The correlation can be identified by the system, a user of the system, or an analytics engine associated with the system.

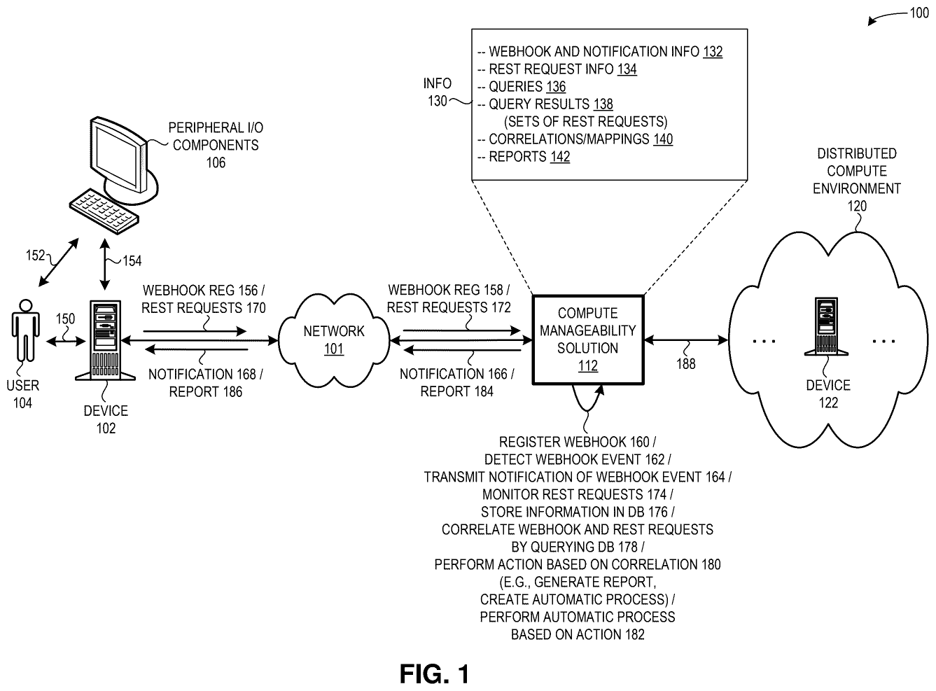

FIG. 1 illustrates an environment 100 which facilitates a framework to predict and automate customer actions in response to webhook notifications, in accordance with an aspect of the present application. Environment 100 can include a device 102 with an associated user 104 and associated peripheral input/output (I/O) components 106, e.g., a display, a keyboard, a mouse (not shown), etc. Device 102, user 104, and components 106 can communicate with each other via communications 150, 152, and 154. Environment 100 can also include a compute manageability solution or system 112 (“system 112”), which can represent a compute management platform providing services accessible via an out of band management (OOBM) interface, e.g., an integrated Lights-Out (ILO) interface (not shown). System 112 may include one or more computing devices or a network of computing devices, and the computing devices can be physical or virtual machines. System 112 can include hardware, software, and a combination of hardware and software components. Device 102 and system 112 can communicate over, e.g., a network 101. Device 102 can be a network device which is associated with a distributed compute environment 120, e.g., a customer network 120. Customer network 120 can include devices, such as a device 122, which are managed and monitored by system 112 and connected to system 112 over the cloud. System 112 can monitor operations and communications which occur in distributed compute environment 120 (via, e.g., a communication 188).

During operation, device 102 can communicate using a REST API. For example, user 104 may type or enter a REST request or command into a command line interface (CLI) using peripheral I/O components 106, which can cause device 102 to send a webhook registration 156 (received as a webhook registration 158) to system 112. System 112 can receive webhook registration 158 and register the webhook (operation 160). Webhook registration 156/158 can request a notification for a first event associated with a first resource monitored by system 112. For example, the first event associated with the first resource may include a port associated with a particular network interface card (NIC) on a particular “server_A” (e.g., device 122) in the customer network 120 flapping, e.g., going up and down, for three or more times a second for a duration of at least five seconds (i.e., “port flapping” or the first event). System 112 can store a mapping of the requested notification to the first event (port flapping) and the first resource (device 122).

System 112 can monitor the operations and communications which occur in distributed compute environment 120. System 112 may detect an occurrence of the first event associated with the first resource (operation 162) (e.g., port flapping associated with a NIC of device 122). Based on the previously registered webhook (in operation 160), system 112 can transmit a notification 166 (received as a notification 168) of the webhook event to device 102 (operation 164). System 112 can also store, in a data structure or database (DB) maintained by system 112, information associated with the notification (operation 176), including, e.g.: a time at which the notification is transmitted; identifying information of device 102 or user 104; and identifying information of the first resource.

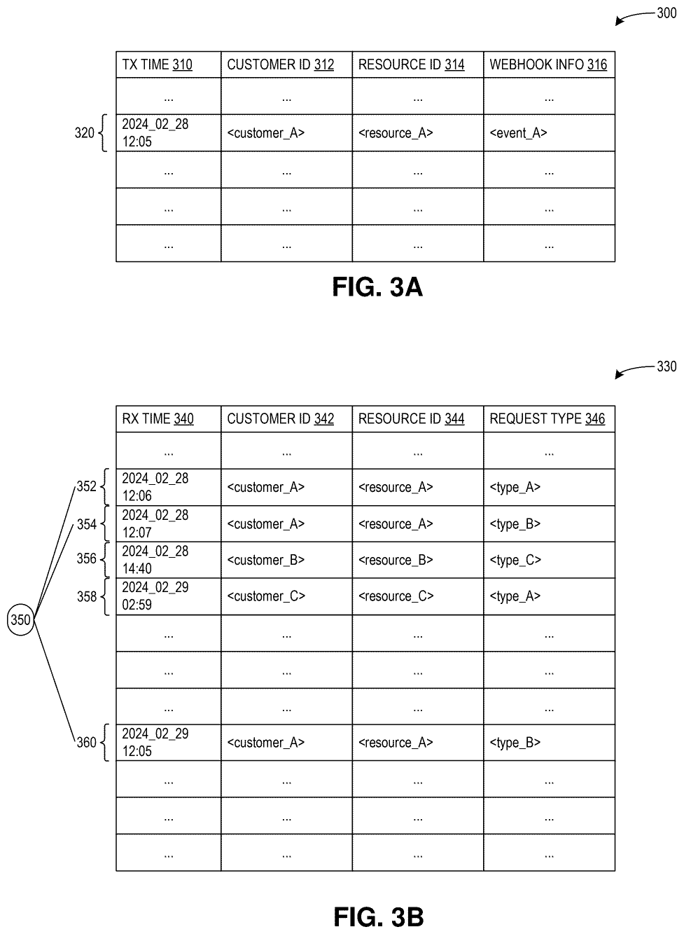

Device 102 can receive notification 168 and perform operations subsequent to receiving notification 168. The operations may include transmitting REST requests 170 (received as REST requests 172) to system 112. For example, subsequent to receiving notification 168 that the first event (port flapping) associated with the first resource (device 122) has occurred, device 102 may send REST requests which include powering off device 122. System 112 can monitor the received REST requests 172 (operation 174) and store, in the data structure or database (DB) maintained by system 112, information associated with the REST requests (operation 176), including, e.g.: a time at which a respective REST request is transmitted; identifying information of device 102 or user 104; identifying information of the first resource; and identifying information of the webhook, i.e., the previously registered webhook including the event and the resource. An example of the data structure maintained by system 112 is described below in relation to FIGS. 3A and 3B.

System 112 can query the database for a set of REST requests associated with the first resource and a predefined period of time (e.g., 12 or 24 hours) and can correlate the webhook and the queried set of REST requests (operation 178). In some aspects, system 112 may send a correlation request to an analytics engine, which can query the data structure and correlate a webhook notification and a resulting set of REST requests, as described below in relation to correlation request 230 and analytics engine 208 of FIG. 2. System 112 can improve the efficiency associated with operating the first resource by performing an action based on the correlation (operation 180). For example, system 112 can generate a report based on any information stored in the database. In some aspects, the action can include the analytics engine generating the report and including the correlation(s). The analytics engine can also provide other information to user 104 of device 102, which information can be displayed on peripheral I/O components 106 of device 102. System 112 can transmit a report 184 (received as a report 186) to device 102. Device 102 can receive report 186 and display report 186 and information associated with report 186 on peripheral I/O components 106.

Customers, such as user 104, may have previously agreed to “opt in” to a configuration which permits automatic procedures to be performed by the compute management platform services of system 112. As a result, the action performed in operation 180 can include system 112 aggregating the set of REST requests (whether correlated to the webhook notification by system 112 or by an analytics engine) into a single REST operation. For example, the correlation may be made between the webhook relating to port flapping on server_A and a set of monitored received REST requests, including powering off server_A, and the single REST operation can include an aggregation of the correlated received REST requests. System 112 can create an automatic process which is to perform the single REST operation (including the aggregated set of REST requests) in response to transmitting the notification requested by the webhook (operation 182).

If user 104 has not previously opted in to the configuration which permits automatic processes, the action performed in operation 180 can include system 112 sending (as part of report 184 or as a separate communication (not shown)) an approval request to user 104. The approval request can indicate that a particular registered webhook event has occurred and can provide an option for user 104 to perform the aggregation (and/or another automatic process), either as a default “opt-in” option or on a one-time basis for that specific approval request only. User 104 may choose to “opt in” to the automatic processes, either as a default “always” or only for the specific instance, or user 104 may choose to decline the approval request. The approval request may include one or more recommended automatic processes. Upon receiving a response to the approval request, the system can act accordingly, i.e., perform the automatic process based on whether the user has provided permission and opted in to the automatic process.

The data structure maintained by system 112 can include at least information 130, e.g.: webhook and notification information 132 (as depicted below in relation to FIG. 3A); REST request information 134 (as depicted below in relation to FIG. 3B); queries 136; and query results 138, including sets of REST requests returned from a respective query. Information 130 can also include correlations/mappings 140, which can indicate a correlation or mapping between a webhook and a set of REST requests, e.g., based on a specific query for REST requests over a predefined period of time and for a particular resource. Information 130 can also include reports 142, which can be generated by system 112 or an analytics engine.

FIG. 2 illustrates a diagram 200 of communications which facilitates a framework to predict and automate customer actions in response to webhook notifications, in accordance with an aspect of the present application. The communications in diagram 200 can be similar to the communications depicted in environment 100 of FIG. 1. Diagram 200 can include communications between a network device 202 (similar to device 102 of FIG. 1), a compute manageability solution or system 204 (“system 204,” which can represent a compute management platform and be similar to system 112 of FIG. 1), a monitored/managed device 206 (similar to device 122 in distributed compute environment 120 of FIG. 1), and an analytics engine 208, which can reside in a same or different network entity or network as system 204.

During operation, network device 202 can register a webhook (operation 210), which requests a notification for a first event associated with a first resource monitored by system 204. System 204 can register the received webhook (operation 212). While monitoring resources and communications of a distributed compute environment (e.g., including monitored/managed device 206), system 204 can detect an occurrence of the registered first event (operation 214), e.g., monitored/managed device 206 can send a notification 215 of the occurrence of the event. System 204 can store information of the webhook notification (operation 216, similar to operation 176 of FIG. 1). The information can be stored, e.g., in a database, data structure, or a non-transitory computer-readable storage medium or memory associated with system 204. System 204 can transmit to network device 202 a notification 218 indicating that the registered webhook event (i.e., the first event associated with the first resource) has occurred.

Subsequently and over some period of time, network device 202 may send a plurality of REST requests 220, which can be received and monitored by system 204 (operation 222). REST requests 220 can be received by system 204 subsequent to system 204 transmitting notification 218 and can subsequently be sent by system 204 to monitored/managed device 206 (communication not shown). System 204 can store information associated with these REST requests (operation 224). The information can include a resource associated with the REST request. The information can be stored in a database or data structure, similar to how the information of the webhook notification is stored. System 204 can query the database for a specific webhook event to obtain a resulting set of REST requests for a resource associated with the specific webhook, and system 204 can correlate the webhook event with the resulting set of REST requests (operation 226).

System 204 can perform an action based on the correlation (operation 228). For example, the action can include aggregating the set of REST requests into a single REST operation and creating an automatic process to perform the single REST operation in response to transmitting the notification (similar to operation 182 of FIG. 1). When system 204 detects the registered event in the future (operation 244), system 204 can store information associated with the webhook notification (operation 246), and transmit a notification 250 to network device 202. System 204 can subsequently perform the automated process (operation 248), which was created in operation 228. The automated process can include performing the single REST operation, which can include performing each of the REST requests aggregated in the single REST operation.

In some aspects, system 204 can perform an action (operation 228) based on the correlation or send a correlation request 230 to analytics engine 208. Analytics engine 208 can query the database associated with system 204 for a set of REST requests over a certain time period and associated with a particular webhook (i.e., an event and a resource) (operation 232, depicted as a database query 234 to system 204 and a returned query results 236 from system 204). Analytics engine 208 can correlate the webhook event and the set of REST requests (operation 232) and generate a report (operation 238), which can include information as described above in relation to operation 180 of FIG. 1. The report can be transmitted back to system 204 (as a report 240). System 204 can also transmit a report 242 back to network device 202 (either as report 240 as generated by analytics engine 208 in operation 238, or a report generated based on operation 228 performed by system 204). In some aspects, subsequent to receiving report 242, a user associated with network device 202 can decide, if not already opted in, to opt in to the automatic process, which can result in the automatic process of operations 244, 246, 248, and 250. The user associated with network device 202 can opt in to the automatic process via an interactive element on report 242 or as part of an approval request and response process, as described above in relation to operations 178, 180, and 182 of FIG. 1.

The action performed by system 204 (operation 228) can thus include, e.g.: creating an automatic process, which triggers operation 248 based on operations 244 and 246; generating a report, which can be sent back as a report 242 to network device 202; transmitting an approval request for an “opt-in” option for an identified correlation and a corresponding automatic process (where the approval request may be part of report 242 or part of a separate set of communications (not shown) between system 204 and network device 202); receiving a report (240) from analytics engine 208 based on a correlation request (230), which can be used by network device 202 to improve the efficiency of the resource; and displaying report 240 or 242 on a display associated with system 204, which can allow an administrative user to perform actions which can improve the efficiency of the resource for a user of network device 202.

FIG. 3A presents a table 300 depicting stored information associated with notifications sent in response to webhooks, in accordance with an aspect of the present application. Table 300 can include entries corresponding to notifications sent in response to an occurrence of a registered webhook event. The entries can include: a transaction (TX) time 310; a customer identifier (ID) 312; a resource identifier (ID) 314; and webhook information 316. For example, an entry 320 for a notification sent in response to an occurrence of “<event_A>” can include: a TX time of “2024_02_28 12:06” for a customer with a customer ID of “<customer_A>” and a resource with a resource ID of “<resource_A>.” The customer ID can include information which identifies a network device (or an associated user) which registered the webhook request (i.e., which requested a notification for the occurrence of “<event_A>” associated with “<resource_A>”).

FIG. 3B presents a table 330 depicting stored information associated with monitored REST requests, in accordance with an aspect of the present application. Table 330 can include entries corresponding to REST requests which are sent by a network device and received by a compute management platform subsequent to the compute management platform transmitting a notification to the network device of the occurrence of a registered webhook event. The entries can include: a received (RX) time 340; a customer ID 342; a resource ID 344; and a request type 346. The request type can indicate a command or request to, e.g., create, read, update, or delete data or records associated with a resource. For example: an entry 352 can indicate a REST request received at an RX time of “2024_02_28 12:06” for a customer with a customer ID of “<customer_A>,” a resource with a resource ID of “<resource_A>,” and a type of “<type_A>”; an entry 354 can indicate a REST request received at an RX time of “2024_02_28 12:07” for a customer with a customer ID of “<customer_A>,” a resource with a resource ID of “<resource_A>,” and a type of “<type_B>”; an entry 356 can indicate a REST request received at an RX time of “2024_02_28 14:40” for a customer with a customer ID of “<customer_B>,” a resource with a resource ID of “<resource_B>,” and a type of “<type_C>”; an entry 358 can correspond to a REST request received at an RX time of “2024_02_29 02:59” for a customer with a customer ID of “<customer_C>,” a resource with a resource ID of “<resource_C>,” and a type of “<type_A>”; and an entry 360 can indicate a REST request received at an RX time of “2024_02_29 12:05” for a customer with a customer ID of “<customer_A>,” a resource with a resource ID of “<resource_A>,” and a type of “<type_B>.”

The compute management platform or solution (e.g., system 112 of FIG. 1 or system 204 of FIG. 2) can query the database (e.g., the structures represented by tables 300 and 330) for a set of REST requests associated with, e.g., a particular customer, resource, and event for a predetermined, predefined, or configurable period of time. For example, the compute management platform can query table 330, based on the information in entry 320 of table 300, for a set of REST requests which pertain to a customer with a customer ID of “<customer_A>” and a resource with a resource ID of “<resource_A>” (which are the customer and resource associated with the “<event_A>” indicating in entry 320 of table 300), and which occur over a predefined period of time (e.g., 24 hours after the TX time indicated in entry 320 of table 300). The resulting set of REST requests 350 can include entries 352, 354, and 360.

The compute management platform can aggregate the set of REST requests 350 into a single REST operation, which can be programmed to automatically be performed in response to detecting another “<event_A>” (as described above in relation to operations 228, 244, 246, and 248 of FIG. 2). The compute management platform can also store the mapping of the webhook indicated in entry 320 and the resulting set of REST requests 350 (which includes aggregated REST requests 352, 354, and 360).

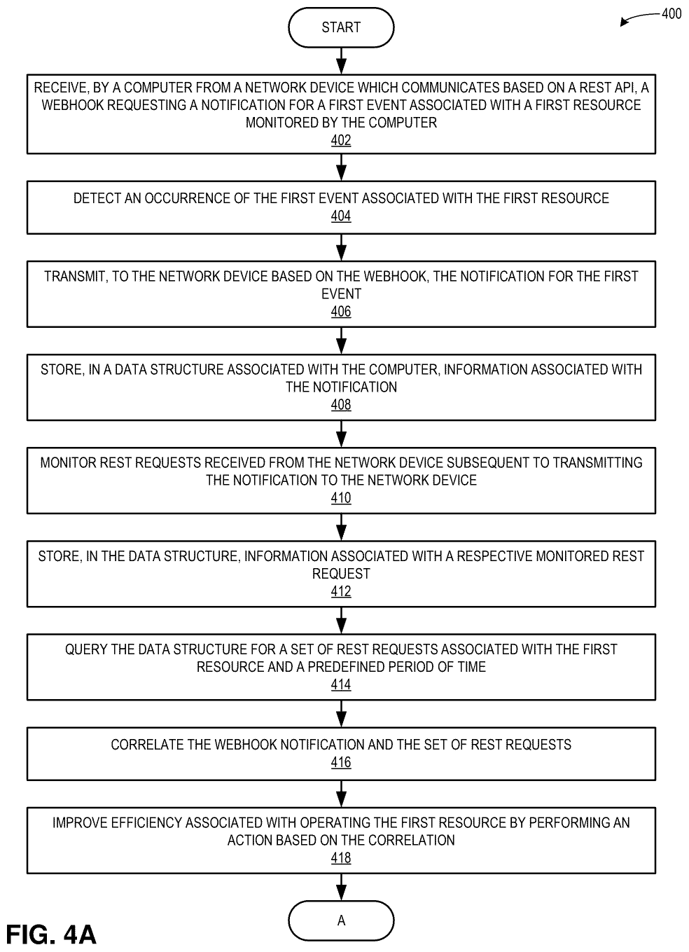

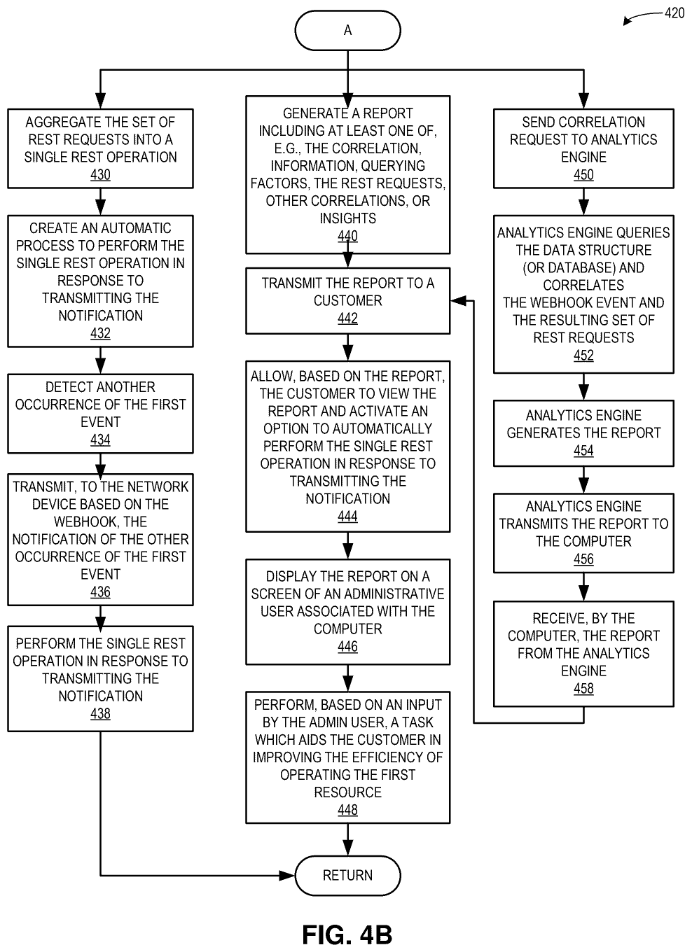

FIG. 4A presents a flowchart 400 illustrating a method which facilitates a framework to predict and automate customer actions in response to webhook notifications, in accordance with an aspect of the present application. During operation, a computer (e.g., a compute management platform or compute manageability solution such as system 112 or system 204) receives, from a network device which communicates based on a REST API, a webhook requesting a notification for a first event associated with a first resource monitored by the computer (operation 402). For example, in FIG. 1, system 112 receives webhook registration 158 (sent as webhook registration 156) from device 102, and in FIG. 2, system 204 receives register webhook communication 210 from network device 202. The computer (e.g., system 112 or system 204) can register the webhook in response to receiving the request, as described above in relation to operations 160 and 212 of, respectively, FIGS. 1 and 2. The computer detects an occurrence of the first event associated with the first resource (operation 404), e.g., as described above in relation to operation 162 and 214 of, respectively, FIGS. 1 and 2. The computer transmits, to the network device based on the webhook, the notification for the first event (operation 406). For example, in operation 164 of FIG. 1, system 112 transmits notification 166 (received as notification 168) to device 102, and in FIG. 2, system 204 transmits notification 218 to network device 202

The computer stores, in a data structure associated with the computer, information associated with the notification (operation 408), as described above in relation to operations 176 and 216 of, respectively, FIGS. 1 and 2. The computer monitors REST requests received from the network device subsequent to transmitting the notification to the network device (operation 410). The computer stores, in the data structure, information associated with a respective monitored REST request (operation 412). For example, as depicted in FIG. 1, system 112 monitors REST requests (operation 174) and stores related information in the database (operation 176), and as depicted in FIG. 2, system 204 monitors REST requests (operation 222) and stores the information of the REST requests (operation 224).

The computer queries the data structure for a set of REST requests associated with the first resource and a predefined period of time (operation 414). For example, the compute management platform (e.g., system 112 of FIG. 1 or system 204 of FIG. 2) can query the database (e.g., the structures represented by tables 300 and 330) for a set of REST requests associated with the first resource and other query factors, e.g., a particular customer and event over a specific time period, as described above in relation to tables 300 and 330 of, respectively, FIGS. 3A and 3B. The query factors may be configured or selected by the computer, an administrator user of the computer (e.g., an administrator or engineer associated with the compute management platform), or a customer associated with the network device. The computer correlates the webhook notification and the set of REST requests (operation 416). The computer can create a mapping between the webhook notification and the set of REST requests. As a result, the computer improves efficiency associated with operating the first resource by performing an action based on the correlation (operation 418), and the operation continues at Label A of FIG. 4B. As described below in FIG. 4B, the action can include: aggregating the set of REST requests and creating an automatic process which is to be performed upon detecting a subsequent occurrence of the webhook event; generating a report, upon which a receiving user or entity may perform an action; and sending a correlation request to an analytics engine.

FIG. 4B presents a flowchart 420 illustrating a method which facilitates a framework to predict and automate customer actions in response to webhook notifications, in accordance with an aspect of the present application. The computer can improve the efficiency associated with operating, as an example, the first resource by performing an action, which can be represented by the three possible techniques from Label A of FIG. 4B. In a first technique, the computer aggregates the set of REST requests into a single REST operation (operation 430) and creates an automatic process which is to be performed as the single REST operation in response to transmitting the notification (operation 432), as described above in relation to operations 180/182 and 228 of, respectively, FIGS. 1 and 2. The computer detects another occurrence of the first event (operation 434) and transmits, to the network device based on the webhook, the notification of the other occurrence of the first event associated with the first resource (operation 436). The computer also stores information associated with the webhook notification. An example of detecting another occurrence, storing information, and transmitting the notification is provided above in relation to operations 162, 164, 176 and notifications 166 and 168 of FIG. 1 as well as operations 244 and 246 and notification 250 of FIG. 2. Operations 434 and 436 can be similar to operations 404 and 406 of FIG. 4A. The computer performs the single REST operation in response to transmitting the notification (operation 438), as described above in relation to operation 248 of FIG. 2, and the operation returns. Because the aggregated set of REST requests of the single REST operation can be performed automatically after subsequent occurrences of the registered webhook event for the first resource, this can result in improved efficiency in the operation of the first resource.

At Label A, in another technique, the system generates a report which includes at least one of, e.g.: the correlation between the webhook and the set of REST requests; the information associated with the notification or the respective REST request; factors used in querying the data structure for the set of REST requests; the set of REST requests aggregated into the single REST operation; one or more other correlations between the webhook notification and other sets of REST requests, wherein the one or more other correlations are determined by querying the data structure based on other factors; or insights related to improving the efficiency associated with operating the first resource, including insights related to the occurrence of the first event and other commonly used REST requests transmitted subsequent to the occurrence of the first event (operation 440). The computer transmits the report to a network device or a customer associated with the network device (operation 442). Generating and transmitting the report are described above in relation to operation 180 and reports 184/186 of FIG. 1 and operation 228 and report 242 of FIG. 2.

The computer allows, based on the report, the customer to: view the report on a display associated with the network device; and activate an option (if not already activated) to automatically perform the single REST operation in response to the network device receiving the notification (operation 444). If the user activates the operation to automatically perform the single REST operation, the operation continues at operation 434. The activation option may be included in the report or may be sent in a separate approval request. The report or the approval request can allow the customer to set other configurable options, e.g., thresholds for accepting recommended aggregations, selecting one or more REST requests to be included in a recommended aggregation, etc.

The computer also displays the report on a screen of an administrative user associated with the computer (operation 446) and performs, based on an input by the administrative user, a task which aids the customer in improving the efficiency associated with operating the first resource (operation 448). The administrative user associated with the computer can be, e.g., an engineer involved in designing or creating the compute management services implemented on and provided by the computer. For example, the administrative user may determine, based on the displayed report, that a particular sequence of REST requests may be most useful for aggregation into the single REST operation, and the administrative user may input information which transmits this option to the customer for further approval (e.g., as part of the report or part of a separate approval request). Thus, the action of generating and displaying the report can involve an interactive process between the customer associated with the network device and the administrative user associated with the computer or compute management platform. The operation returns.

At Label A, in yet another technique, the computer can send a correlation request to an analytics engine (operation 450), as described above in relation to correlation request 230 of FIG. 2. The analytics engine (e.g., analytics engine 208 of FIG. 2) may be located on a same or different device or network as the computer (e.g., system 204 of FIG. 2). The analytics engine queries the data structure(s) (or database) for a set of REST requests and correlates the webhook event and the resulting set of REST requests (operation 452), as described above in relation to operations 232, 234, and 236 of FIG. 2. The analytics engine generates a report (operation 454) (e.g., report 240 of FIG. 2), which can be similar to or different from the report (e.g., report 242 of FIG. 2) generated by the computer. The report can include similar items as described above and can also include the factors used by the analytics engine in the query (or queries) to obtain one or more resulting sets of REST requests. The analytics engine transmits the report to the computer (operation 456) and the computer receives the report from the analytics engine (operation 458), as described above in relation to report 240 of FIG. 2. Subsequently, the operation continues as described above at operation 442, i.e., the computer transmits the report (e.g., report 242 of FIG. 2) to a customer).

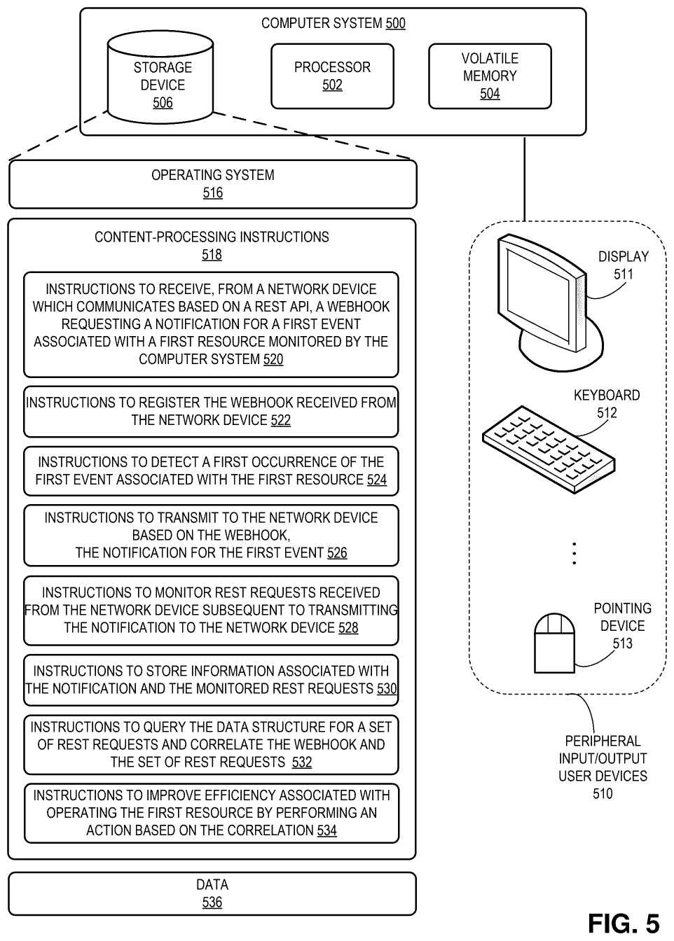

FIG. 5 illustrates a computer system 500 which facilitates a framework to predict and automate customer actions in response to webhook notifications, in accordance with an aspect of the present application. Computer system 500 includes at least one processing resource (e.g., a processor 502), a memory 504, and a storage device 506. Memory 504 can include a volatile memory (e.g., random access memory (RAM)) that serves as a managed memory and can be used to store one or more memory pools. Furthermore, computer system 500 can be coupled to peripheral I/O user devices 510 (e.g., a display device 511, a keyboard 512, and a pointing device 513). Storage device 506 includes non-transitory computer-readable storage medium and stores an operating system 516, content-processing instructions 518, and data 536. Computer system 500 may include fewer or more entities or instructions than those shown in FIG. 5. Content-processing instructions 518 can include instructions, which when executed by processor 502, can cause computer system 500 to perform methods and/or processes described in this disclosure.

Specifically, content-processing instructions 518 may include instructions 520 to receive, from a network device which communicates based on a REST API, a webhook requesting a notification for a first event associated with a first resource monitored by the computer system, as described above in relation to operation 402 of FIG. 4A. Content-processing instructions 518 may include instructions 522 to register the webhook received from the network device, as described above in relation to operation 212 of FIG. 2. Content-processing instructions 518 may include instructions 524 to detect a first occurrence of the first event associated with the first resource, as described above in relation to operation 404 of FIG. 4A. Content-processing instructions 518 may include instructions 526 to transmit, to the network device based on the webhook, the notification for the first event, as described above in relation to operation 406 of FIG. 4A. Content-processing instructions 518 may include instructions 528 to monitor REST requests received from the network device subsequent to transmitting the notification to the network device, as described above in relation to operation 410 of FIG. 4A. Content-processing instructions 518 may include instructions 530 to store, in a data structure associated with the computer system, information associated with the notification and information associated with the monitored REST requests, as described above in relation to, respectively, operations 408 and 412 of FIG. 4A. Content-processing instructions 518 may include instructions 532 to query the data structure for a set of REST requests associated with the first resource over a period of time and correlate the webhook notification and the set of REST requests, as described above in relation to operations 414 and 416 of FIG. 4A. Content-processing instructions 518 may include instructions 534 to improve efficiency associated with operating the first resource by performing an action based on the correlation, as described above in relation to operation 418 of FIG. 4A and the operations of FIG. 4B.

Data 536 can include any data that is required as input or that is generated as output by the methods, operations, communications, and/or processes described in this disclosure. Specifically, data 536 can store at least: a request; a command; a REST request; a webhook; a notification; an indicator of a first event associated with a first resource; an indication of detection of the first event; a data structure; information associated with a notification; information associated with a monitored REST request; a query; a factor used in a query; results of a query; a set of REST requests; a correlation between a webhook notification and a set of REST requests; an action; an aggregated set of REST requests; a single REST operation; an insight related to improving efficiency associated with operating a resource; a report; a report or other information generated by an analytics engine; an input by an administrative user; a time at which a notification is transmitted; identifying information of a network device or a customer associated with the network device; identifying information of a resource; a time at which at REST request is transmitted; identifying information of a webhook; and identifying information of an event or a type of event.

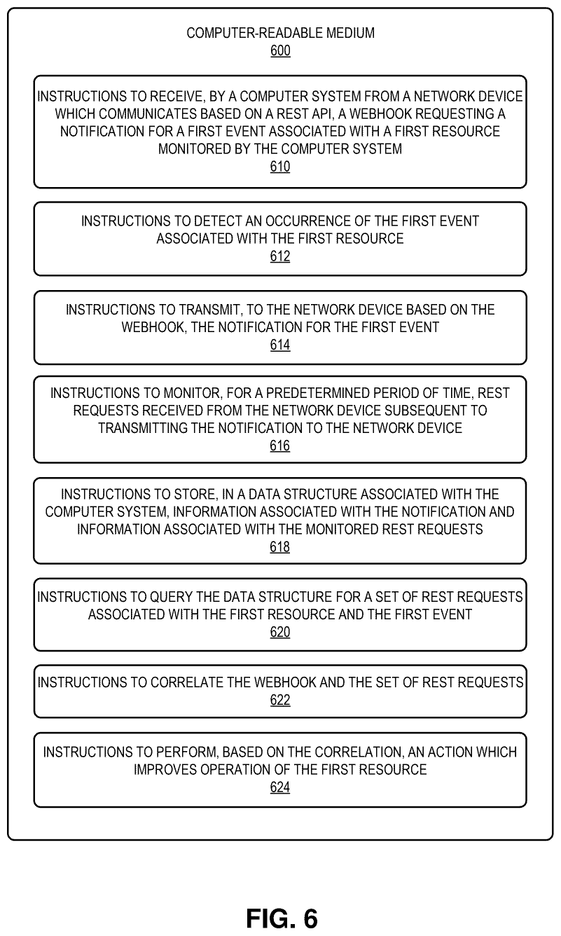

Computer system 500 and content-processing instructions 518 may include more instructions than those shown in FIG. 5. For example, content-processing instructions 518 can also store instructions for executing the operations described above in relation to: the environment of FIG. 1; the communications of FIG. 2; the operations depicted in the flowcharts of FIGS. 4A-4B; and the instructions of non-transitory computer-readable medium 600 in FIG. 6.

FIG. 6 illustrates a computer-readable medium 600 which facilitates a framework to predict and automate customer actions in response to webhook notifications, in accordance with an aspect of the present application. CRM 600 can be a non-transitory computer-readable medium or device storing instructions that when executed by a computer or at least one processing resource (e.g., a processor (not shown)) cause the computer or at least one processing resource to perform a method.

CRM 600 can store instructions 610 to receive, by a computer system from a network device which communicates based on a REST API, a webhook requesting a notification for a first event associated with a first resource monitored by the computer system, as described above in relation to operation 402 of FIG. 4A. CRM 600 can store instructions 612 to detect an occurrence of the first event associated with the first resource, as described above in relation to operation 404 of FIG. 4A. CRM 600 can store instructions 614 to transmit, to the network device based on the webhook, the notification for the first event, as described above in relation to operation 406 of FIG. 4A. CRM 600 can store instructions 616 to monitor, for a predetermined period of time, REST requests received from the network device subsequent to transmitting the notification to the network device, as described above in relation to operation 410 of FIG. 4A. CRM 600 can store instructions 618 to store, in a data structure associated with the computer system, information associated with the notification and information associated with the monitored REST requests, as described above in relation to, respectively, operations 408 and 412 of FIG. 4A. CRM 600 can store instructions 620 to query the data structure for a set of REST requests associated with the first resource and the first event over a specific period of time, as described above in relation to operation 414 of FIG. 4A. CRM 600 can store instructions 622 to correlate the webhook and the set of REST requests, as described above in relation to operation 416 of FIG. 4A. CRM 600 can store instructions 624 to perform, based on the correlation, an action which improves operation of the first resource, as described above in relation to operation 418 of FIG. 4A and the operations of FIG. 4B.

CRM 600 may include more instructions than those shown in FIG. 6. For example, CRM 600 can also store instructions for executing the operations described above in relation to: the environment of FIG. 1; the communications of FIG. 2; the operations depicted in the flowcharts of FIGS. 4A-4B; and the instructions of computer system 500 in FIG. 5.

In general, the disclosed aspects provide a method, a computer system, and a computer-readable medium for facilitating a framework to predict and automate customer actions in response to webhook notifications. During operation, in an environment which includes a computer (e.g., a compute management platform, solution, or system) and a network device which communicates using a web-based protocol (e.g., REST API), the computer receives from the network device a webhook requesting a notification for a first event associated with a first resource monitored by the computer. The computer detects an occurrence of the first event associated with the first resource. The computer transmits, to the network device based on the webhook, the notification for the first event. The computer stores, in a data structure associated with the computer, information associated with the notification. The computer monitors requests received from the network device using the web-based protocol subsequent to transmitting the notification to the network device. The computer stores, in the data structure, information associated with a respective monitored request. The computer queries the data structure for a set of requests associated with the first resource and a predefined period of time. The computer correlates the webhook notification and the set of requests. The computer improves efficiency associated with operating the first resource by performing an action based on the correlation.

In a variation on this aspect, the action comprises: aggregating the set of requests into a single operation; and creating an automatic process to perform the single operation in response to transmitting the notification.

In a further variation, subsequent to performing the action based on the correlation, the computer detects another occurrence of the first event associated with the first resource. The computer transmits, to the network device based on the webhook, the notification of the other occurrence of the first event associated with the first resource. The computer performs the single operation in response to transmitting the notification.

In a further variation, the action comprises generating a report including at least one of: the correlation between the webhook notification and the set of requests; the information associated with the notification; the information associated with the respective request; factors used in querying the data structure for the set of requests; the set of requests aggregated into a single operation; one or more other correlations between the webhook notification and other sets of requests, wherein the one or more other correlations are determined by querying the data structure based on other factors; or insights related to improving the efficiency associated with operating the first resource, including insights related to the occurrence of the first event and other commonly used requests transmitted subsequent to the occurrence of the first event.

In a further variation, the computer transmits the report to a customer associated with the network device. The computer allows the customer to: view the report on a display associated with the network device; and activate an option to automatically perform the single REST operation in response to the network device receiving the notification. The computer displays the report on a screen of an administrative user associated with the computer. The computer performs, based on an input by the administrative user, a task which aids the customer in improving the efficiency associated with operating the first resource.

In a further variation, the information associated with the notification and stored in the data structure comprises at least: a time at which the notification is transmitted; identifying information of the network device or of a customer associated with the network device; and identifying information of the first resource. The information associated with the respective request comprises at least: a time at which the respective request is transmitted; identifying information of the network device or of a customer associated with the network device; identifying information of the first resource; and identifying information of the webhook.

In a further variation, querying the data structure for the set of request and correlating the webhook notification and the set of requests are performed by an analytics engine associated with the computer.

In a further variation, the web-based protocol comprises at least one of: a Representational State Transfer (REST) application programming interface (API); a Simple Object Access Protocol (SOAP) API; an API based on Hypertext Transfer Protocol (HTTP); or an API based on HyperText Markup Language (HTML), Extensible Markup Language (XML), or JavaScript Object Notation (JSON).

In another aspect, a computer system comprises a processor and a storage device storing instructions which when executed by the processor are to perform certain operations. The instructions are to receive, from a network device which communicates based on a web-based protocol, a webhook requesting a notification for a first event associated with a first resource monitored by the computer system. The instructions are further to register the webhook received from the network device. The instructions are further to detect a first occurrence of the first event associated with the first resource. The instructions are further to transmit, to the network device based on the webhook, the notification for the first event. The instructions are further to monitor requests received from the network device using the web-based protocol subsequent to transmitting the notification to the network device. The instructions are further to store, in a data structure associated with the computer system, information associated with the notification and information associated with the monitored requests. The instructions are further to query the data structure for a set of requests associated with the first resource over a period of time. The instructions are further to correlate the webhook notification and the set of requests. The instructions are further to improve efficiency associated with operating the first resource by performing an action based on the correlation. The computer system may include content-processing instructions which include the instructions to perform the operations described herein, including in relation to: the environment of FIG. 1; the communications of FIG. 2; the operations depicted in the flowcharts of FIGS. 4A-4B; the instructions of computer system 500 of FIG. 5; and the instructions of non-transitory computer-readable medium 600 in FIG. 6.

In another aspect, a non-transitory computer-readable storage medium (or CRM) stores instructions which when executed by at least one processing resource are to receive, by a computer system from a network device which communicates using a web-based API, a webhook requesting a notification for a first event associated with a first resource monitored by the computer system. The instructions are further to detect an occurrence of the first event associated with the first resource. The instructions are further to transmit, to the network device based on the webhook, the notification for the first event. The instructions are further to monitor, for a predetermined period of time, requests received from the network device using the web-based API subsequent to transmitting the notification to the network device. The instructions are further to store, in a data structure associated with the computer system, information associated with the notification and information associated with the monitored requests. The instructions are further to query the data structure for a set of requests associated with the first resource and the first event. The instructions are further to correlate the webhook notification and the set of requests. The instructions are further to perform, based on the correlation, an action which improves operation of the first resource. The CRM can also store instructions for executing the operations described above in relation to: the environment of FIG. 1; the communications of FIG. 2; the operations depicted in the flowcharts of FIGS. 4A-4B; the instructions of computer system 500 in FIG. 5; and the instructions of non-transitory computer-readable medium 600 in FIG. 6.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
receiving, by the computer from a network device which communicates using a web-based protocol, a webhook requesting a notification for a first event associated with a first resource monitored by the computer;
detecting an occurrence of the first event associated with the first resource;
transmitting, to the network device based on the webhook, the notification for the first event;
storing, in a data structure associated with the computer, information associated with the notification;
monitoring requests received from the network device using the web-based protocol subsequent to transmitting the notification to the network device;
storing, in the data structure, information associated with a respective monitored request;
querying the data structure for a set of requests associated with the first resource and a predefined period of time;
correlating the webhook notification and the set of requests; and
improving efficiency associated with operating the first resource by performing an action based on the correlation.

2. The computer-implemented method of claim 1, wherein the action comprises:
aggregating the set of requests into a single operation; and
creating an automatic process to perform the single operation in response to transmitting the notification.

3. The computer-implemented method of claim 2, further comprising:
subsequent to performing the action based on the correlation, detecting another occurrence of the first event associated with the first resource;
transmitting, to the network device based on the webhook, the notification of the other occurrence of the first event associated with the first resource; and
performing the single operation in response to transmitting the notification.

4. The computer-implemented method of claim 1, wherein the action comprises generating a report including at least one of:
the correlation between the webhook notification and the set of requests;
the information associated with the notification;
the information associated with the respective request;
factors used in querying the data structure for the set of requests;
the set of requests aggregated into a single operation;
one or more other correlations between the webhook notification and other sets of requests, wherein the one or more other correlations are determined by querying the data structure based on other factors; or
insights related to improving the efficiency associated with operating the first resource, including insights related to the occurrence of the first event and other commonly used requests transmitted subsequent to the occurrence of the first event.

5. The computer-implemented method of claim 4, further comprising:
transmitting the report to a customer associated with the network device; and
allowing the customer to:
view the report on a display associated with the network device;
activate an option to automatically perform the single operation in response to the network device receiving the notification;
displaying the report on a screen of an administrative user associated with the computer; and
performing, based on an input by the administrative user, a task which aids the customer in improving the efficiency associated with operating the first resource.

6. The computer-implemented method of claim 1,
wherein the information associated with the notification and stored in the data structure comprises at least:
a time at which the notification is transmitted;
identifying information of the network device or of a customer associated with the network device; and
identifying information of the first resource; and
wherein the information associated with the respective request comprises at least:
a time at which the respective request is transmitted;
identifying information of the network device or of a customer associated with the network device;
identifying information of the first resource; and
identifying information of the webhook.

7. The computer-implemented method of claim 1,
wherein querying the data structure for the set of requests and correlating the webhook notification and the set of requests are performed by an analytics engine associated with the computer.

8. The computer-implemented method of claim 1, wherein the web-based protocol comprises at least one of:
a Representational State Transfer (REST) application programming interface (API);
a Simple Object Access Protocol (SOAP) API;
an API based on Hypertext Transfer Protocol (HTTP); or
an API based on HyperText Markup Language (HTML), Extensible Markup Language (XML), or JavaScript Object Notation (JSON).

9. A computer system, comprising:
a processor; and
a storage device storing instructions which when executed by the processor are to:
receive, from a network device which communicates based on a web-based protocol, a webhook requesting a notification for a first event associated with a first resource monitored by the computer system;
register the webhook received from the network device;
detect a first occurrence of the first event associated with the first resource;
transmit, to the network device based on the webhook, the notification for the first event;
monitor requests received from the network device using the web-based protocol subsequent to transmitting the notification to the network device;
store, in a data structure associated with the computer system, information associated with the notification and information associated with the monitored requests;
query the data structure for a set of requests associated with the first resource over a period of time;
correlate the webhook notification and the set of requests; and
improve efficiency associated with operating the first resource by performing an action based on the correlation.

10. The computer system of claim 9, the instructions to perform the action based on the correlation further to:
aggregate the set of requests into a single operation;
create an automatic process to perform the single operation in response to transmitting the notification;
subsequent to performing the action based on the correlation, detect a second occurrence of the first event associated with the first resource;
transmit, to the network device based on the webhook, the notification of the second occurrence of the first event associated with the first resource; and
perform the single operation subsequent to transmitting the notification.

11. The computer system of claim 9, the instructions to perform the action based on the correlation further to generate a report including at least one of:
the correlation between the webhook notification and the set of requests;
the information associated with the notification;
the information associated with the respective request;
factors used in querying the data structure for the set of requests;
the set of requests aggregated into a single operation;
one or more other correlations between the webhook notification and other sets of requests, wherein the one or more other correlations are determined by querying the data structure based on other factors; or
insights related to improving the efficiency associated with operating the first resource, including insights related to the occurrence of the first event and other commonly used requests transmitted subsequent to the occurrence of the first event.

12. The computer system of claim 11, the instructions further to:
transmit the report to a customer associated with the network device; and
allow the customer to:
view the report on a display associated with the network device; and
activate an option to automatically perform the single operation in response to the network device receiving the notification.

13. The computer system of claim 11, the instructions further to:
display the report on a screen of an administrative user associated with the computer system; and
perform, based on an input by the administrative user, a task which aids the customer in improving the efficiency associated with operating the first resource.

14. The computer system of claim 9,
wherein the information associated with the notification and stored in the data structure comprises at least:
a time at which the notification is transmitted;
identifying information of the network device or of a customer associated with the network device; and
identifying information of the first resource, and
wherein the information associated with the respective request and stored in the data structure comprises at least:
a time at which the respective request is transmitted;
identifying information of the network device or of a customer associated with the network device;
identifying information of the first resource; and
identifying information of the webhook.

15. The computer system of claim 9, wherein the web-based protocol comprises at least one of:
a Representational State Transfer (REST) application programming interface (API);
a Simple Object Access Protocol (SOAP) API;
an API based on Hypertext Transfer Protocol (HTTP); or
an API based on HyperText Markup Language (HTML), Extensible Markup Language (XML), or JavaScript Object Notation (JSON).

16. A non-transitory computer-readable medium storing instructions which when executed by at least one processing resource are to:
receive, by a computer system from a network device which communicates using a web-based application programming interface (API), a webhook requesting a notification for a first event associated with a first resource monitored by the computer system;
detect an occurrence of the first event associated with the first resource;
transmit, to the network device based on the webhook, the notification for the first event;
monitor, for a predetermined period of time, requests received from the network device using the web-based API subsequent to transmitting the notification to the network device;
store, in a data structure associated with the computer system, information associated with the notification and information associated with the monitored requests;
query the data structure for a set of requests associated with the first resource and the first event;
correlate the webhook notification and the set of requests; and
perform, based on the correlation, an action which improves operation of the first resource.

17. The non-transitory computer-readable medium of claim 16, wherein the instructions to perform the action are further to:
aggregate the set of requests into a single operation;
create an automatic process to perform the single operation in response to transmitting the notification;
subsequent to performing the action based on the correlation, detect another occurrence of the first event associated with the first resource;
transmit, to the network device based on the webhook, the notification of the other occurrence of the first event associated with the first resource; and
perform the single operation subsequent to transmitting the notification.

18. The non-transitory computer-readable medium of claim 16, wherein the instructions to perform the action are further to generate a report including at least one of:
the correlation between the webhook notification and the set of requests;
the information associated with the notification;
the information associated with the respective request;
factors used in querying the data structure for the set of requests;
the set of requests aggregated into a single operation;
one or more other correlations between the webhook notification and other sets of requests, wherein the one or more other correlations are determined by querying the data structure based on other factors; or
insights related to improving the efficiency associated with operating the first resource, including insights related to the occurrence of the first event and other commonly used requests transmitted subsequent to the occurrence of the first event;
wherein generating the report is performed by the computer system or an analytics engine in communication with the computer system.

19. The non-transitory computer-readable medium of claim 18, wherein the instructions are further to:
transmit the report to a customer associated with the network device;
allow the customer to:
view the report on a display associated with the network device; and
activate an option to automatically perform the single operation in response to the network device receiving the notification;
display the report on a screen of an administrative user associated with the computer system; and
perform, based on an input by the administrative user, a task which aids the customer in improving the efficiency associated with operating the first resource.

20. The non-transitory computer-readable medium of claim 19, wherein the instructions are further to:
transmit an anonymized report to an engineer associated with the computer system; and
allow the engineer to:
view the aggregated anonymized reports across all customers on a display associated with the computer system; and
improve a product associated with the computer system by making operations of a respective customer more efficient.
